(19) United States
(12) Patent Application Publication
(10) Pub. No.: US 2025/0259561 A1
(43) Pub. Date: Aug. 14, 2025

(54) INTERACTIVE DIGITAL LEARNING SYSTEM

(71) Applicant: RICH Learning Global, Stillwater, MN (US)

(72) Inventors: Richard Melheim, Stillwater, MN (US); Janakan Arulkumarasan, Singapore (SG)

(21) Appl. No.: 19/046,810

(22) Filed: Feb. 6, 2025

Related U.S. Application Data
(60) Provisional application No. 63/551,917, filed on Feb. 9, 2024.

(51) Int. Cl. G09B 5/06; G06F 21/62; G06N 20/00

(52) U.S. Cl. CPC G09B 5/065; G06F 21/6254; G06N 20/00

(57) ABSTRACT

An interactive digital learning system may include a server application and a client application. The system may be configured to provide media content to the client application to be played to a user. In examples, the media content may be part of a curriculum and may include one or more of videos, song, and activities. The system may further include a plurality of machine learning models configured to receive user interaction data and to perform one or more tasks of a plurality of potential tasks. One or more of the machine learning models may be trained at least in part on data that is specific to a background of the user.

### CROSS-REFERENCE TO RELATED APPLICATIONS

The present application claims priority from U.S. Provisional Patent Application No. 63/551,917, filed on Feb. 9, 2024, the disclosure of which is hereby incorporated by reference in its entirety.

### BACKGROUND

Educational technology (EdTech) encompasses the intersection of technology and education. EdTech may have the potential to improve learning outcomes. However, there may be various technical challenges in EdTech. For example, effective teaching may require that the learner be engaged, but some technology used in education may be static, unengaging, and ultimately ineffective. In some instances, EdTech may be limited to teaching a particular task or a particular segment of the population. Furthermore, some EdTech may not be configured to understand or respond to inputs from a learner. Even if the technology can receive such inputs, the technology may be limited by the range of inputs that it can evaluate and may be limited by the range of responses it can provide.

### SUMMARY

Aspects of the present disclosure relate to an interactive digital learning system. The system can include a backend that includes an application, media content, and an artificial intelligence (AI) system that includes a plurality of machine learning models. The media content, which may include lessons that include videos, songs, and activities, may be provided to a user device. The device may play the content, capture user interaction data (e.g., user speech, movement, or emotion indicators), evaluate the interaction data using machine learning models, and provide feedback to the user. As a result, the digital learning system may provide an engaging and content-rich digital learning environment to the user.

In a first aspect, an interactive digital learning system is disclosed. The system comprises a server; and a client device communicatively coupled with the server; wherein the server comprises a processor and memory storing instructions that, when executed by the processor, cause the server to: fine-tune a machine learning model using training data specific to a background of a user by: collecting data from a target segment of a global population, the target segment having features that correspond to the background of the user; based on the data collected from the target segment of the global population, generating training samples for training the machine learning model to perform a task; selecting a pre-trained base model for the machine learning model; and training the pre-trained base model using the training samples; deploy the machine learning model to the client device of the user; stream media content associated with a lesson to the client device; wherein the client device comprises a second processor and second memory storing second instructions that, when executed by the second processor, cause the client device to: receive the deployed machine learning model; receive the streamed media content associated with the lesson; play the streamed media content to display the media content on a screen; capture, using a sensor, user interaction data in real time; apply the machine learning model to compare, in real time at the client device, the streamed media content and the user interaction data; based on the comparison of the streamed media content and the user interaction data, generate feedback; and display the feedback on the screen.

In a second aspect, a method for facilitating an interactive digital education system is disclosed. The method comprises by a server: generating media content, at least some of the media content being associated with a curriculum; training a plurality of machine learning models, wherein each machine learning model of the plurality of machine learning models is trained using data associated with a different user background, wherein training a machine learning model of the plurality of machine learning models comprises: collecting data from a target segment of a global population, the target segment having features that correspond to a background of a user; based on the data collected from the target segment of the global population, generating training samples for training the machine learning model to perform a task; selecting a pre-trained base model for the machine learning model; and training the pre-trained base model using the training samples; distributing the media content across a plurality of client devices; and deploying the plurality of machine learning models across the plurality of client devices; by a client device of the plurality of client devices: playing the media content using a screen and a speaker; capture, using a sensor, user interaction data; and apply the machine learning model on the client device to compare the media content and the user interaction data.

In a third aspect, a system for facilitating digital interaction with machine learning. The system comprises a server communicatively coupled with a client device via a network; wherein the server is configured to: access data for a target segment of a global population, the target segment having features that correspond to a background of a user associated with the client device; using the data for the target segment of the global population, generate labeled training samples for training a machine learning model to perform a task; select a pre-trained base model for the machine learning model; train the pre-trained base model using the labeled training samples; and deploy the machine learning model to the client device; wherein the client device is configured to: receive the deployed machine learning model; receive media content; play the media content; capture, using a sensor, user interaction data; and apply the machine learning model at the client device to evaluate the user interaction data.

### BRIEF DESCRIPTION OF THE DRAWINGS

FIG. 1 illustrates a schematic example of aspects of the present disclosure.

FIG. 2 illustrates an example network environment in which aspects of the present disclosure may be implemented.

FIG. 3 is a flowchart of an example method for providing content of the digital learning system to a user.

FIG. 4 is a flowchart of an example method including operations of an artificial intelligence (AI) system.

FIG. 5 is a flowchart of an example method for generating training data.

FIG. 6 is a flowchart of an example method for training a model.

FIG. 7 is a flowchart of an example method for performing inference.

FIG. 8 is a flowchart of an example method including operations of a blockchain system.

FIG. 9 is a flowchart of an example method for interacting with a digital learning system.

FIG. 10 illustrates a block diagram of an example computing system.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments.

In example aspects, an interactive digital learning system is disclosed. The system may provide media content to a plurality of different computing platforms, including, for example, mobile phones or virtual reality environments. As examples, the media content may include the following types of media: videos; audio; images; 3D objects; activities; and games. In some embodiments, the media content may relate to teaching one or more of the following: language, virtue, mathematics, science, health, the arts, or another field. Furthermore, the media content may be categorized into various lessons, with each lesson including one or more of a video or a song, along with one or more interactive activities.

In example aspects, the system may use AI. For instance, the system may use one or more machine learning models as part of interacting with a user. As an example, the system may provide media content to a client device. The media content may include a video followed by an activity in which the user reads aloud, dances, practices speaking a phrase from a foreign language, or completes another activity. As an example, the system may capture the user's speech, use a trained speech recognition model to evaluate the user's speech, and then provide feedback to the user. The feedback may be, for example, a correction, a score, or a reward, which may be a crypto token or an unlocking of new content.

In some embodiments, the speech recognition model (and other machine learning models described herein) may be trained with training data that is specific to the background of the user and the task the user is performing. For example, if the user is a Spanish-speaking child from Costa Rica learning English, then the speech recognition model deployed for use with that child may be fine-tuned or trained with data associated with Spanish-speaking children from Costa Rica learning English. In example aspects, other machine learning models are likewise possible, such as machine learning models for performing tasks related to emotion recognition, movement recognition, language translation, content filtering, query-response tasks, image recognition, and other tasks that may facilitate interactions with the user. Such machine learning models may also be trained based at least in part using training data that is specific to the user's background and the task that the user is performing.

In example aspects, the digital learning system may also include other features. For example, the digital learning system may include crypto tokens. For example, the system may create fungible or non-fungible tokens on a blockchain, and one or more of a server-side, client-side, or other application may be configured to exchange the tokens. As an example, a user may receive tokens after a completion of an activity, and the user may exchange the tokens for assets in the digital learning system. Other example features of the digital learning system may include a supervisor application, user and administrative dashboards, a content generation system, robust security and encryption techniques, analytics tools, and other features that are described further herein.

Aspects of the present disclosure may provide various technical benefits. In some embodiments, by training machine learning models on data that is specific to children and to children of a specific background, the precision, accuracy, recall, and other performance metrics of the machine learning models may be improved when used for children of that background. Furthermore, by developing different machine learning models by using data corresponding to a plurality of different backgrounds, and then selectively using one or more of the machine learning models based on the background of the user, the performance of the system may not only be improved for particular population segments but may also be improved more generally. Yet still, by deploying, in some instances, a plurality of machine learning models to client devices and performing inference on the client devices, user data may be better protected, and the performance of the models may be improved. Additionally, in some embodiments, different machine learning models may be developed for different tasks, thereby expanding the range of interactions that are possible between the digital learning system and users.

Yet still, in example aspects, the digital learning system may improve learning outcomes by integrating advances in neuroscience and computer technology. For example, by using a blend of art, storytelling, and movement, the user's brain may be activated and better able to understand and retain information, and by using AI systems to understand the user, interactive content may be effectively used at times when the user is ready to engage. Furthermore, in example embodiments, the digital learning system may be implemented effectively at a global scale, due at least in part to a plurality of machine learning models that are trained with data associated with people from diverse backgrounds and performing a diverse array of activities. As will be apparent, these are only some of the advantages offered by aspects of the present disclosure.

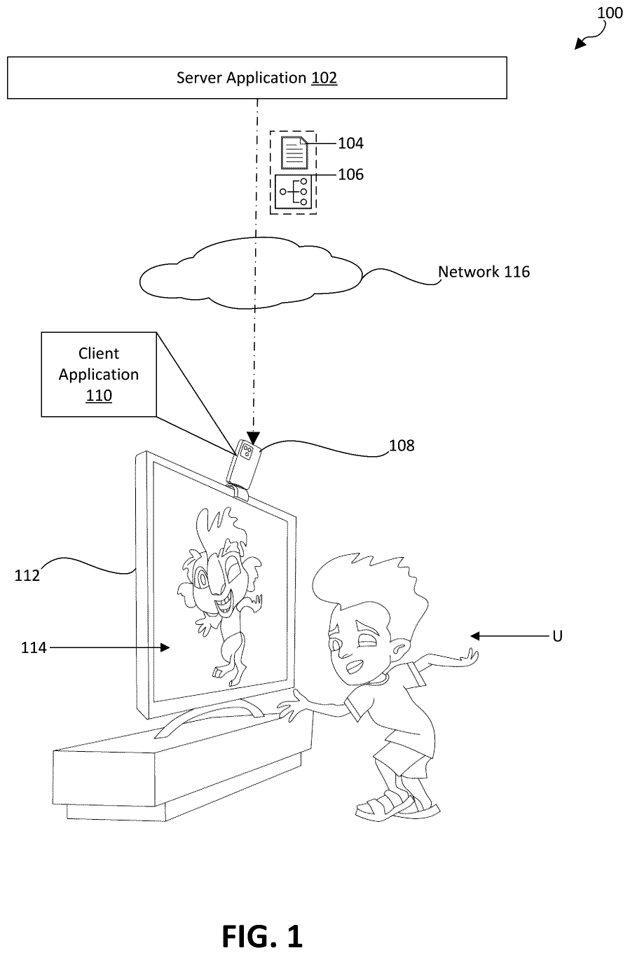

FIG. 1 illustrates an example 100 of aspects of the digital learning system. The example 100 includes a user U, a server application 102, media content 104, a machine learning model 106, a device 108, a client application 110, a device 112, a display 114, and a network 116.

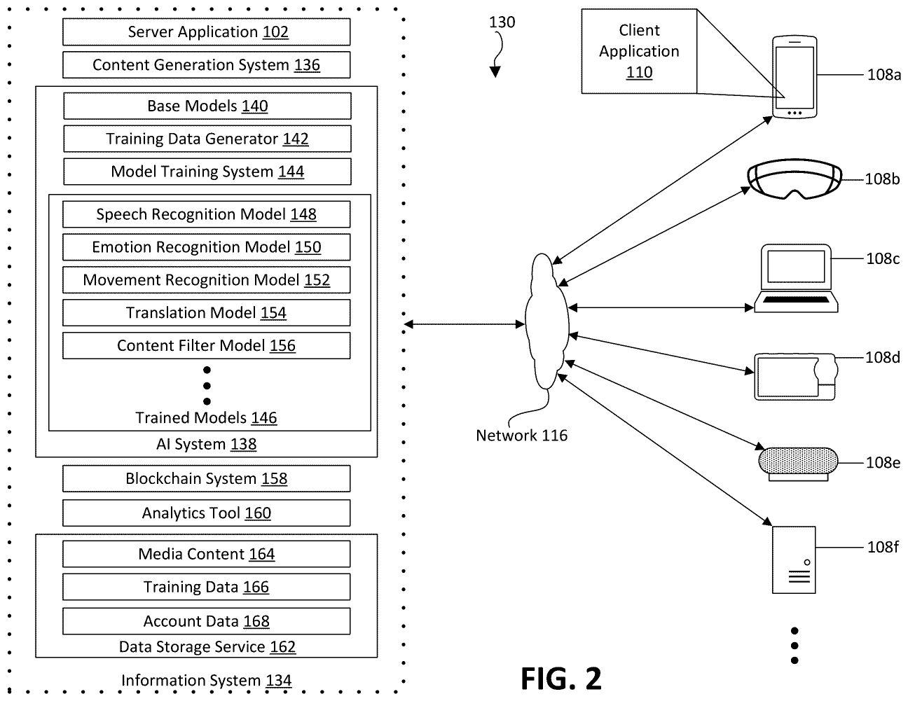

The server application 102 may include backend software and hardware that is part of a digital learning system. In some embodiments, the server application 102 receives requests from the client application 110 and, in response, provides content to the client application 110. In some embodiments, the server application 102 orchestrates data exchanges and executions of other backend components, such as one or more components of the information system 134, which is further described in connection with FIG. 2. In some embodiments, the server application 102 may operate in connection with or include one or more of an application server, a web server, a database server, a network server, a proxy server, or another type of server.

In some embodiments, the server application 102 may be a cloud or hybrid cloud application. In some embodiments, the server application 102 may include a plurality of different applications that may be communicatively coupled with one another. In some embodiments, implementation aspects of the server application 102 may depend on the computing platform in which the client application 110 is implemented. For example, if the client application 110 is a web browser, then the server application 102 may include a web server. In a similar manner, the server application 102 may be implemented to complement different potential embodiments of the client application 110. Example aspects of the server application 102 are further described in connection with FIG. 2.

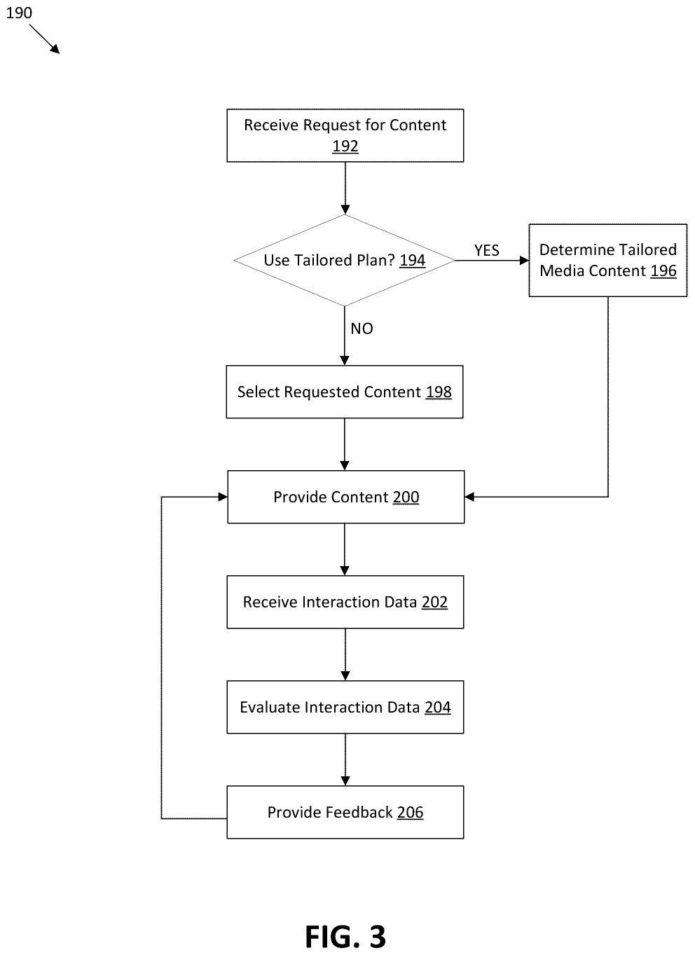

The media content 104 may be media that is provided from the server application 102 to the device 108. For example, the media content 104 may be streamed from the server application to the device 108, the device 108 may download the media content 104, or the server application 102 may provide the content 104 to the device 108 in another manner. In some embodiments, the media content 104 may be played by the client application 110 using one or more output devices of the device 108 or device 112. As one example, the device 108 may then play streamed media content, which may include playing audio data of the media content via a speaker or displaying visual data of the media content on a screen. In some embodiments, the media content 104 may relate to education. In some instances, the media content 104 may have been requested by the user U, whereas in other instances, the media content 104 may have been determined at least in part by the server application 102 using a tailored learning plan for the user U, a process that is further described in connection with FIG. 3. In the example of FIG. 1, the content 104 may include a video and an activity that asks the user U to copy a dance of a character in the content 104. Additional aspects of the media content 104 are further described below in connection with the media content 164 of FIG. 2.

The machine learning model 106 may be a trained machine learning model that is provided by the server application 102 to the device 108. The client application 110 may use the machine learning model 106 to perform a task using an input received from the user U. The task may relate to the content 104. In the example of FIG. 1, the machine learning model 106 may be configured to evaluate movement of the user U and determine a similarity between the user U and the movement depicted by the content 104, which is illustrated by the display 114. Additional aspects of the machine learning model 106 are described in connection with the AI system 138 of FIG. 2.

The device 108 may be a computing device including a processor, memory, input and output components, non-transitory computer-readable media, and other computer components. In some embodiments, the device 108 is a media playback device. In some embodiments, the device 108 includes sensors, such as a camera and microphone, for capturing interaction data of the user U. In some embodiments, the device 108 may be a mobile device, such as a mobile phone, tablet, or smart device. In some embodiments, the device 108 may be a virtual reality headset. In some embodiments, the device 108 may be a plurality of devices that are communicatively coupled (e.g., both a mobile phone and a sensor that is attached to the user U and that is communicatively coupled with the mobile phone). Examples of the device 108 are illustrated and described below in connection with the devices 108a-f of FIG. 2. The device 108 may be configured to execute the client application 110, which may be installed on the device 108 or may otherwise accessible (e.g., over the internet) to the device 108.

In the example of FIG. 1, the device 108 is coupled with the device 112. In some embodiments, the device 108 may be physically coupled with the device 112. For example, the device 108 may be mounted onto the device 112, or the device 108 may be coupled to the device 112 with wires. In some embodiments, the device 108 may be communicatively coupled with the device 112. For example, the device 108 may cast a display to the device 112 or otherwise exchange data with the device 112. In some embodiments, the device 108 and the device 112 (and other Internet of Things (IoT)) devices may be communicatively coupled via Bluetooth, Thread, a local Wi-Fi network, or another type of network. In some embodiments, the device 112 is not directly communicatively coupled with the server application 102, but instead may receive data from the server application 102 via the client application 110. In some embodiments, the device 112 is a television.

The client application 110 may be an application that may be configured to, among other things, play media content. In some embodiments, the client application 110 may include one or more of software, firmware, or dedicated hardware. The client application 110 may include instructions that are executed by a processor of the device 108. The characteristics of the client application 110 may depend on characteristics of the device 108, such as the available memory, processing power, and communication capabilities of the device 108, or whether the device 108 includes a display screen. In some embodiments, the client application 110 is a mobile application (e.g., a native mobile app); in others, the client application 110 may be a web browser or a web application; in others, the client application 110 may be a virtual reality application. In some embodiments, different versions of the client application 110 may be implemented across different computing environments. For instance, for the case in which the device 108 is a mobile phone, the client application 110 may be a mobile app, and for the case in which the device 108 is a VR headset, the client application 110 may be a VR app. In some embodiments, the client application 110 may be communicatively coupled with the server application 102. In some embodiments, the client application 110 may be developed by or otherwise associated with an entity that develops or is otherwise associated with the server application 102. Such an entity could be, for example, an EdTech organization.

In some embodiments, the client application 110 includes user components and supervisor components. The user components may enable the user U (who may be a child) to play and interact with content provided by the client application 110, such as educational content. The supervisor components may include features for establishing setting for the user components. For example, the supervisor components may enable a second user (e.g., a parent or other supervisor) to set which content is available to the user U, to establish privacy settings data pertaining to the user U, to enable or configure a content filter, to establish settings or parameters for machine learning models used by the client application 110, to monitor the user U, or to perform other functions. In some embodiments, a first instance of the client application 110 that includes the user components may be installed on a first device (e.g., the device 108) and a second instance of the client application 110 that includes the supervisor components may be installed on a second device (e.g., a device associated with a parent or supervisor). Although not depicted illustrated in the example of FIG. 1, one or more of the second device or the supervisor user may be part of the digital learning system.

In the example of FIG. 1, the client application may receive a request from the user U to play content that includes a dance. In response to this request, the client application 110 may determine whether the content is cached or otherwise stored locally at the device 108. If not, the client application 110 may send a request for content to the server application 102. The server application 102 may then provide the content 104 to the client application, which may then play aspects of the content 104. The client application 110 may then capture user interaction data using components of the device 108, such as user movement, facial expressions, or speech. After evaluating the captured user interaction data, the client application 110 may provide feedback. Furthermore, the client application 110 may then provide additional content, receive user interaction data associated with the additional content, provide additional feedback data, and so on. Additional aspects of the client application 110 are further described below in connection with FIGS. 2, 3, and 10.

The device 112 may be a computing device with the characteristics described in connection with the device 108. In the example shown, the device 112 is a TV that is communicatively coupled with the device 108. The display 114 may be part of an output device of the device 108 or the device 112. In the example shown, the display 114 is a screen of the device 112. The display 114 may show content that is rendered by the device 108 or 112. In the example shown, the display 114 shows aspects of the content 104 sent from the server application 102 to the device 108. For example, the display 114 shows a singing and dancing character that is to be mimicked by the user U.

The user U may be a user of the client application 110. In some embodiments, the user U is a student. In some embodiments, the user U is a child. In some embodiments, the linguistic, ethnic, or cultural background of the user U may vary from one situation to the next. For example, in one instance, the user U may be a native speaker of Spanish from Costa Rica, whereas in another instance, the user U may be a native speaker of Mandarin Chinese from China. The user U may interact with the client application 110 to play content, and the client application 110 may capture interaction data of the user U, which may include, but may not be limited to speech, movement, images, or facial expressions of the user U, as well as data corresponding to documents, images, or other activities performed by the user U.

The network 116 may communicatively couple components of the digital learning system, including, for example, the server application 102 with the client application 110. In some embodiments, the network 116 may be, for example, a wireless network, a wired network, a virtual network, the internet, another type of network, or a combination of different network types. The network 116 may be a public network, private network, or a combination thereof. The network 116 may be divided into subnetworks, and the subnetworks may be different types of networks.

FIG. 2 illustrates an example digital learning system 130 in which aspects of the present disclosure may be implemented. In the example shown, the digital learning system 130 includes devices 108a-f, information system 134, and the network 116. In some embodiments, the digital learning system 130 may include more or fewer components than those described in connection with FIG. 2. As illustrated by the example of FIG. 2, the digital learning system 130 may be a distributed computing environment with a plurality of devices-and a plurality of device types-communicatively coupled to one another directly or indirectly. In some embodiments, there may be different types of computing devices than those illustrated in the example of FIG. 2.

The devices 108a-f may be client computing devices. The devices 108a-f may be examples of the device 108 described in connection with FIG. 1. Each of the devices 108a-f may be configured to execute aspects of the client application 110. For example, the devices 108a-f may have the client application 110 installed thereon, or the devices 108a-f may be configured to access aspects of the client application 110 over a network. In some instances, one or more of the devices 108a-f may download the client application 110 from an application store or a website.

Depending on the device, the embodiment of the client application 110 may vary. For example, the implementation of the client application 110 may be different for the virtual reality (VR) headset 108b than for the laptop 108c, or the implementation of the client application 110 may be different for a mobile phone running Android than a mobile phone running iOS. In some embodiments, although the implementation of the client application 100 may vary across computing platforms, at least some aspects of the backend, which may include the server application 102 and other components of the information system 134 may be consistent across implementations. In some embodiments, at least some aspects of the server application 102 and other components of the information system 134 may be tailored to specific implementations of the client application 110.

The mobile phone 108a may be a smart phone. The mobile phone 108a may include various built-in input and output devices, such as a camera, microphone, speaker, and display screen. The mobile phone 108a may be configured to connect with another device (e.g., a TV) for displaying output of the client application 110. For the mobile phone 108a, the client application may be a native mobile application or a web application that is accessed by a web browser of the mobile phone 108a.

The VR headset 108b may be a device that the user wears over his or her eyes. The VR headset 108b may generate a 3D visual environment. The VR headset 108b may also generate audio. In some embodiments, the VR headset 108b is communicatively coupled with other devices used to track user movements, such as controllers or other sensors. In some embodiments, the VR headset 108b may include built-in sensors that track user movement without additional equipment. In some embodiments, the VR headset 108b includes built-in speakers to capture user speech. In some embodiments, the VR headset 108b enables the user to access a metaverse. For the VR headset 108b, the client application 110 may be implemented for a VR-specific platform and may be developed with software development kits tailored to generating 3D content and receiving inputs from a 3D environment. For embodiments in which the VR headset 108b is used, the user may be able to interact with characters in a 3D environment. Activities, videos, images, text, and other media content may occur in the 3D environment, the user interaction data may be collected from the 3D environment, and the machine learning models may be configured to evaluate data from interactions that occur in the 3D environment.

The laptop 108c may be a computer that includes the client application 110 installed thereon. The device 108d may be a device that is customized to operate as part of the interactive digital learning system. For example, the device 108d may be developed or associated with the same entity that developed or is associated with the server application 102 and the client application 110. In some embodiments, the device 108d includes hardware, firmware, and software that is dedicated to running the client application 110 and to facilitating communication between the client application 110 and other programs. In some embodiments, the device 108d may be integrated into a larger computing system, such as a network of smart devices, a digital media delivery system, a smart home, or a car. The hub 108e may be an IoT hub that can access and execute aspects of the client application 110. In some embodiments, the hub 108e is configured to seamlessly integrate with other devices in the proximity of the user. In some embodiments, the hub 108e may include a voice assistant. In some embodiments, the hub 108e may include a screen, whereas in other embodiments, the hub 108e may not have a screen. The server 108f is a device that may host the client application 110 so that aspects of the client application 110 accessed by other devices. For example, the server 108f may be a web server, application server, or another type of server. In some embodiments, the device 108 is a combination of the devices 108a-f.

The client devices that may be part of an interactive digital learning system are not limited to those depicted in connection with FIG. 2. For example, there may be additional devices that execute aspects of the client application 110 or that are coupled with devices that execute the client application 110. As an example, the interactive digital learning system may also include sensors or other IoT devices. The sensors may include devices for capturing interaction data from user U, such as a camera or microphone. The sensors may also include sensors for determining health metrics, such as heart rate, blood pressure, or other metrics. For example, the sensors may include a heart rate sensor attached to the user. They may also include devices for sensing or analyzing ambient conditions, such as lighting, noise, and so on. In some embodiments, the sensors and other IoT devices may be coupled to a device that runs the client application 110, such as phone. Depending on the embodiment, the communication among the device running the client application 110 and the other devices may be performed over Bluetooth, Thread, Zigbee, Z-Wave, Wi-Fi, or another communication protocol.

In some embodiments, the devices 108a-f may communicate with components of the information system 134. For example, the devices 108a-f may receive one or more of the client application 110, media content 164, and trained models 146 from components of the information system 134. Furthermore, the devices 108a-f may provide subscription information, anonymized analytics data, and other information to components of the information system 134.

The information system 134 may be a collection of software, hardware, networks, data, and people. The information system 134 may be associated with an organization. For example, the organization may use, develop, maintain, own, or otherwise be associated with the components of the information system 134. In some embodiments, the information system 134 is associated with a media content provider, such as an entity that stores media content, streams media content, and provides other services related to media content. As an example, the entity may be an EdTech organization.

The information system 134 may include one or more frontend systems (e.g., the client application 110) via which the devices 108a-f may interact with the information system 134, and the information system 134 may include one or more backend interfaces for facilitating communication with the frontend systems. Some components of the information system 134 may operate in a common computing environment. Some components of the information system 134 may operate in different computing environments and communicate over a network, such as the internet, a local-area network, or a software-defined network.

As shown, the information system 134 may include the server application 102, a content generation system 136, an AI system 138, a blockchain system 158, an analytics tool 160, and a data storage service 162.

The server application 102 may include a plurality of components that perform backend services in the digital learning system. For example, these services may include but are not limited to the following: storing, securing, managing, and distributing data, including media content and user data; integrating with third-party systems; performing user authentication tasks; training, validating, updating, and deploying AI models; managing computational load by scaling and load balancing; defining application programming interfaces (APIs) and calling APIs of other programs; performing and reporting analytics; managing the distribution, versioning, and access levels of instances of the client application 110; exchanging data with the client application 110 across a plurality of different computing environments; performance optimization; orchestrating the exchange of data and execution of applications across other programs and components of the information system 134; and performing other tasks. In some embodiments, the server application 102 may include various software developments kits (SDKs) and other tools. Additionally, the server application 102 may be implemented across different software applications and computing environments.

The content generation system 136 may create media content that is used by one or more of the client application 110 or the server application 102. The content generation system 136 may include hardware and software for creating audio, video, text, and other types of media. In some embodiments, some of the media content 164 may be generated by the content generation system 136. In some embodiments, the content generation system 136 is a mixture of digital and non-digital systems. In some embodiments, the content generation system 136 includes generative AI.

The media content 164 may include various types of media, including but not limited to the following: images; text; audio; video; 3D content; a combination of media types; and other media types. The media content 164 may include characters, stories, songs, cartoons, movies, online and offline activities, metaverse features, e-commerce features, a combination of media, and other media. The file format of the media content 164 may vary depending on the embodiment and the type of media content.

In some embodiments, the media content 164 forms a digital learning curriculum. As an example, the curriculum may include different subjects, such as language, virtue, math, science, health, and arts. Each of the subjects may include lessons. Each of the subjects may be represented as a tower, and each lesson may be a floor within a tower. For example, the language tower may be an English literacy tower with thirty-six lessons represented by thirty-six levels. Each lesson may be associated with content for teaching the lesson. In some embodiments, the media content 164 includes a cast of characters from an imaginary world, and the media content 164 may enable a user to explore and learn about the imaginary world, thereby engaging the user and improving the user's understanding and retention. In some embodiments, different imaginary worlds and stories are woven into the media content 164.

As an example, a lesson in the literacy tower may relate to teaching vowels. The lesson may include a video with a song that describes the vowels. Following the video, there may be an activity, which may require physical movement from the user. For example, the lesson may instruct the student to mimic a tap dance of a character in the lesson. Furthermore, the lesson may include live or offline activities related to learning vowels. The live activities may include a game in which the user speaks or interacts with content provided by the lesson. The offline activities may be a tasked performed separately by the user, such as writing down the vowels or teaching the vowels to a parent. In some instances, the combination of games implemented as activities and subsequent rewards results in a gamification of the media content that further improves user engagement and learning outcomes. Throughout the lesson, interaction data of the user may be captured, and the media content may be selected or altered based in part on an evaluation of the media content (e.g., if it is determined that the user is unengaged, then an upbeat song or video may be played to reengage the user). Capturing and evaluating user interaction data is further described in connection with FIG. 3. Following successful completion of the lesson, the user may receive a reward (e.g., a crypto coin) and may unlock an additional lesson, thereby enabling the user to progress through each lesson of a subject.

In some embodiments, the media content 164 may include content in addition to or instead of content related to a digital learning curriculum. For example, the content generation system 136 may create content that is unrelated to education. As another example, the media content 164 may include media that is received from a third-party service. In some embodiments, the media content 164 may include AI-generated content. The AI-generated content may be part of the digital learning curriculum, such as AI-generated character features (e.g., like voice or appearance), AI-generated responses to queries, AI-generated images, text, or videos, or other AI-generated content. In some embodiments, the AI-generated content may not be related to the digital learning curriculum.

The AI system 138 may include software, hardware, networks, data, and people for developing, training, maintaining, distributing, monitoring, and otherwise managing AI programs. In some embodiments, a plurality of computing systems and entities may form the AI system 138. In the example shown, the AI system 138 includes base models 140, a training data generator 142, a model training system 144, and trained models 146. The AI system 138 may include more or fewer components than those depicted in FIG. 2. For example, the AI system 138 may also include a model deployment service, an analytics service, a reporting service, a configuration system, and other systems.

The base models 140 may include untrained or pre-trained machine learning models. In some embodiments, the base models 140 may be fine-tuned or further trained for implementation in the interactive digital learning system. This may include, for example, modifying the architecture of the base models (e.g., by adding or removing one or more layers or task-specific functions) or training the base models 140 with data that is relevant for the interactive digital learning system.

In some embodiments, some of the base models 140 are already at least partially trained, and some of the base models 140 may not yet be trained. In some embodiments, the base models 140 use neural networks. In some embodiments, the base models implement a transformer architecture. In some embodiments, the base models 140 convert incoming data into embeddings and then update the embeddings based on the context of the data and the learned weights of the model. In some embodiments, certain parameters of the base models 140 may be configurable. The base models 140 may include various types of machine learning models, and a different base model of the base models 140 may be selected depending on the task for which the model is to be deployed. Examples of the base models 140 may include BERT, GPT, LLAMA, a convolutional neural network, or other models. As will be understood by those having skill in the art, different base models of the base models 140 may have different layers, different types of connections between layers, different activation functions, different objective functions, different weighting schemes, different learning and backpropagation techniques, different manners of encoding and decoding data, and other differences.

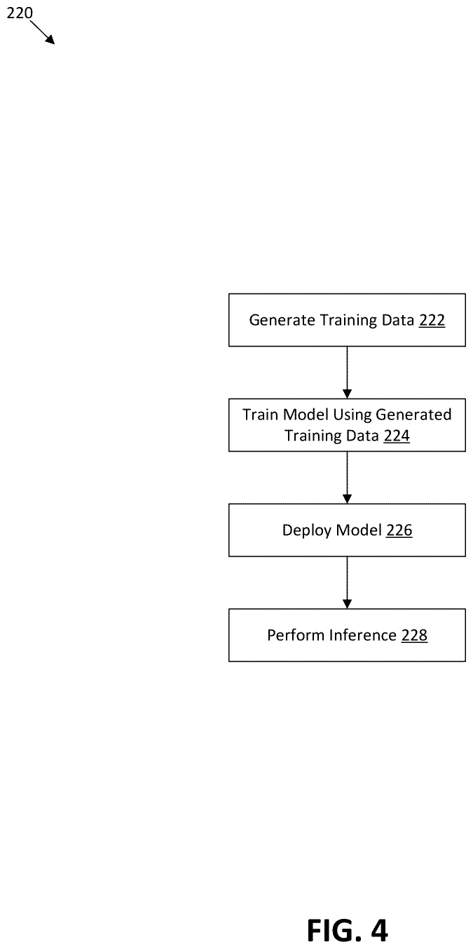

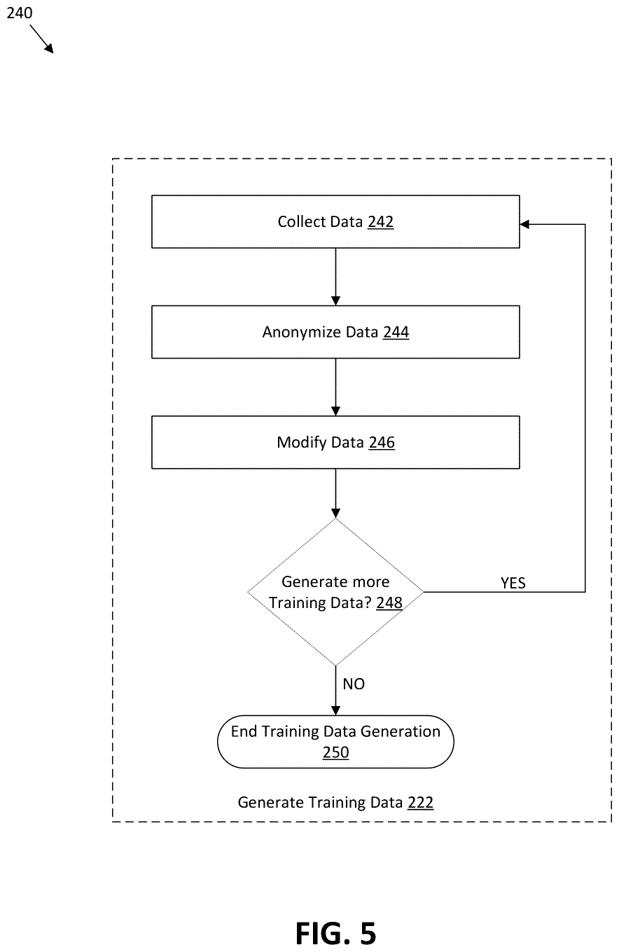

The training data generator 142 may be a system or group of systems for generating training data, which may, in some instances, be used to fine-tune the base models 140. In some embodiments, the training data generator 142 may perform one or more of collecting training data samples, modifying the training data samples, generating synthetic training data, or performing other tasks. Examples of generating training data are further described in connection with FIGS. 4-5.

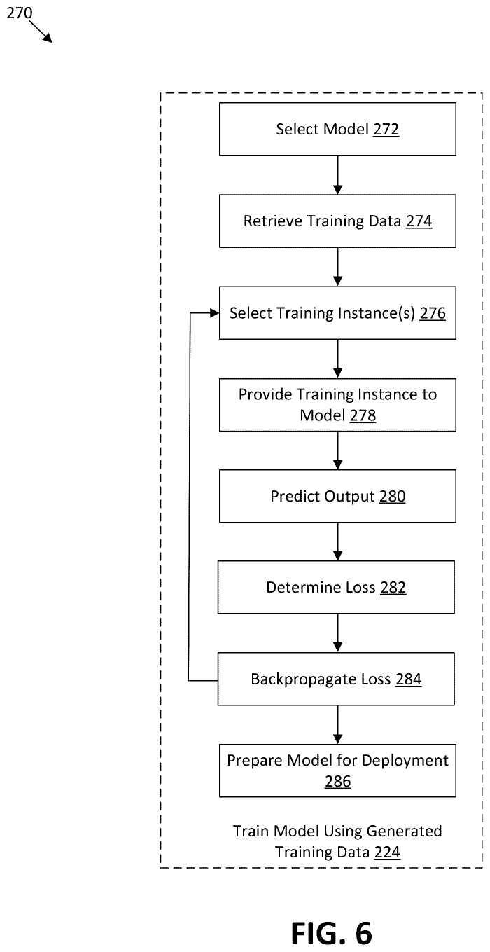

The model training system 144 may include software and hardware for training machine learning models. In some embodiments, the model training system 144 includes clusters of graphics processing units (GPU) to train machine learning models. In some embodiments, the model training system 144 is a cloud-based based machine learning platform, or the model training system 144 interacts with a cloud-based machine learning platform. An example of training a machine learning model is further described in connection with FIG. 6.

The trained models 146 include one or more trained machine learning models of the information system 134. In some embodiments, one or more of the trained models includes a base model of the base models 140 that is fine-tuned for a specific task. In some embodiments, one or more of the trained models 146 may be provided to the client application 110 so that the one or more models may be used on the device on which the client application 110 is operating. The trained models 146 may include more models than those described in connection with FIG. 2. In some embodiments, one or more of the models of the trained models 146 may include an ensemble of machine learning models, and each of the one or more models 146 may include components for pre- and post-processing data. In some embodiments, one or more of the trained models 146 may include different versions that are fine-tuned to be used with users from particular backgrounds. For example, one or more of the models may be fine-tuned using data related to a particular age range, ethnicity, facial structure, physical trait, cultural background, linguistic background, or other characteristic. Some examples of such models are described herein.

The speech recognition model 148 may be configured to identify features of speech. This may include speech of the user U. For example, the speech recognition model 148 may be configured to identify audio characteristics of the speech, including frequencies, amplitudes, and other audio characteristics. Furthermore, the speech recognition model 148 may be configured to infer letters and words of the speech based at least in part on the identified audio characteristics. In some embodiments, the speech recognition model 148 may be further configured to determine a sentiment associated with the speech (e.g., whether the speech is spoken in an enthused or disengaged manner), thereby capturing, in some instances, information in the speech that may go beyond the spoken words.

In some embodiments, the speech recognition model 148 is fine-tuned for a speaker having a particular background and for a speaker performing a particular task. For example, there may be a plurality of speech recognition models 148 that are used for different speakers. There may be, for instance, a speech recognition model that is trained to recognize speech of Spanish-speaking children learning English, there may be a different speech recognition model that is trained to recognize speech of English-speaking children learning Spanish, there may be a different speech recognition trained to recognize speech of French-speaking children learning Mandarin Chinese, and so on. For each of a plurality of such permutations, there may be a speech recognition model, and when the speech recognition model 148 is deployed, a speech recognition model may be selected based at least in part on data of the user whose speech is to be recognized so as to match the user with the speech recognition model trained for the user's background and the task the user is learning.

The emotion recognition model 150 may be a model for detecting emotion of a user. For example, the emotion recognition model 150 may be configured to analyze images of the user's facial expression, and based on this analysis, identify an emotion of the user. In some embodiments, the emotion recognition model 150 may be further configured to identify emotion based on one or more of movements or speech of the user.

In some embodiments, the emotion recognition model 150 may be configured to identify an emotion for users from a particular background. For example, there may be a plurality of emotion recognition models that are used to identify emotions of users of different ages, ethnicities, and cultures, in a similar manner as described in connection with the speech recognition model 148.

The movement recognition model 152 may be configured to recognize movement of the user. In some embodiments, the movement recognition model 152 may be configured to determine whether the user is correctly performing one or more dance steps. As an example, a media item played by the client application 110 may be a video illustrating a ballet routine and instructing the user to copy the routine. The movement recognition model 152 may be configured to then analyze video or image data of the user to evaluate the user's accuracy in performing the ballet routine.

The translation model 154 may be a model for translating media from a first language to a second language. For example, the translation model 154 may be configured to translate one or more of a text, song, video, speech, or audio file from a first language to a second language. In some embodiments, the translation model 154 may include a plurality of models configured to translate different types of media from and to different languages.

The content filter model 156 may be a model that filters content from other machine learning models. For example, the content filter model 156 may receive a potential output of a model and determine whether that potential output is permissible. In some embodiments, the content filter model 156 may be trained to recognize media content, whether it be text, audio, or visual media content, that is potentially offensive, illegal, or otherwise inappropriate to output. In some embodiments, the content filter model 156 may be modified based on a particular user. For example, the content filter model 156 may be trained or otherwise used differently depending on a user's age, background, values, location, or other characteristic. In some embodiments, settings of the content filter model 156 may be established by a supervisor user of the client application 110.

Other models are likewise possible. For example, the AI system 138 may include generative AI models. For example, the AI system 138 may include a model that generates a response to a query, such as a chat bot. As another example, the AI system 138 may include a model that generates visual or audio aspects of a character in the media content. As another example, the AI system 138 may include a model that generates videos, songs, text, or other media content, which may, in some instances, be integrated with the media content 164.

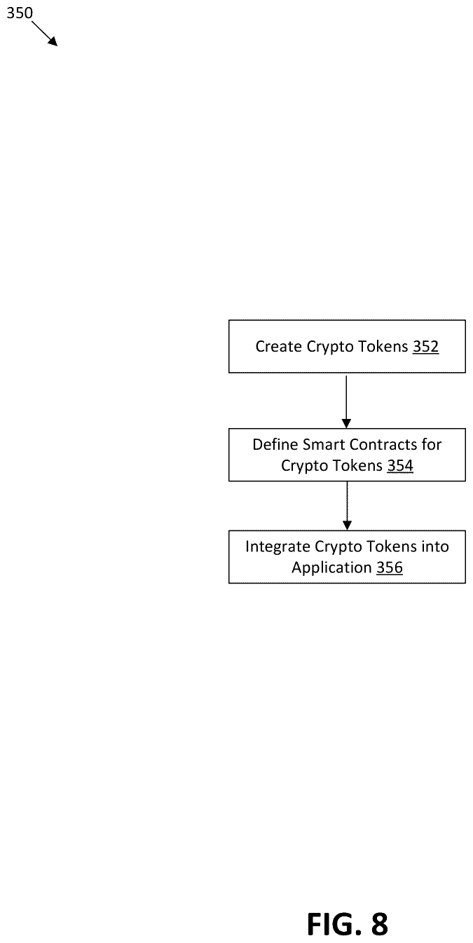

The blockchain system 158 may include a blockchain and one or more software applications or hardware systems that interact with the blockchain. The blockchain may be a public blockchain or a private blockchain. In some embodiments, the blockchain may be Ethereum or a similar blockchain. In some embodiments, the blockchain may be used as part of creating crypto tokens for the digital learning system. For example, processing and recording the creation and transfer of the crypto tokens, which may be fungible or non-fungible tokens depending on the embodiments, may use the blockchain. In some embodiments, the crypto tokens may be used within an ecommerce feature of the digital learning environment. For example, users may be awarded tokens after successful completion of a lesson or subject. In some embodiments, smart contracts are deployed to the blockchain that may be used as part of facilitating transfers of the crypto tokens. In some embodiments, one or more of the server application 102 or the client application 110 may include components configured to communicate with the blockchain system 158 and ultimately with the one or more underlying blockchains. Example aspects of the blockchain system 158 are further described in connection with FIG. 8.

The analytics tool 160 may be used to collect, analyze, and report data relevant to the interactive digital learning system. For example, the analytics tool 160 may be used to track a user's progress through the media content 164. In such an example, aspects of the analytics tool may be accessed by the devices 108a-f so that a user may track, via a graphical user interface displaying a dashboard, his or her progress. As another example, the analytics tool 160 may be used by an administrator of the information system 134 to track metrics related to user engagement, subscription levels, the media content 164, and other data related to the interactive digital learning system. In some embodiments, the analytics tool 160 may include one or more dashboards or graphic user interfaces (GUIs) for presenting analysis and for providing an administrator with tools to search, filter, export, and otherwise explore the data. In some embodiments, the analytics tool 160 includes a log and a program for analyzing the log data to identify patterns, anomalies, and other features in the log data.

The data storage service 162 includes databases and software applications for accessing data in the databases. In some embodiments, the data storage service 162 is a cloud data storage service. In some embodiments, the data storage service 162 implements techniques for encrypting, securing, and anonymizing the data. In the example shown, the data storage service 162 includes media content 164, training data 166, and account data 168. The data storage service 162 may include more or less data than depicted in connection with FIG. 2. Example aspects of the media content 164 are described in connection with the content generation system 136.

The training data 166 includes data that may be used by the AI system 138 to train machine learning models. Depending on the embodiment and depending on the model with which the training data is to be used, the training data 166 may be labeled or unlabeled. Example aspects of the training data 166 are described in connection with the training data generator 142 and in connection with FIGS. 4-5.

The account data 168 may include account data and settings of users of the interactive digital learning system. For example, for a given user, the account data 168 may include data related to a computing platform used by the user, biographical information, payment information, historical activity data, data related to a subscription level of the user, privacy settings associated with the user, the user's progress through a curriculum, whether the user has a tailored learning plan, and if so, settings of the tailored learning plan. Other account and settings data is likewise possible.

FIG. 3 is a flowchart of an example method 190 for providing content of the interactive digital learning system to the user U. In the example of FIG. 3, the method 190 is described as being performed for a given lesson of the media content 164. However, the method 190 may be used to provide content for less than a lesson, for more than one lesson, or for content that is unrelated to a curriculum. As described herein, the method 190 may be performed by components described in connection with FIG. 2. However, operations of the method 190 may be performed by different components than the components described in connection with FIG. 3.

At operation 192, the server application 102 may receive a request for content. For example, via an API exposed by the server application 102, the server application 102 may receive a request from the client application 110 for content. In some embodiments, the request may include data related to a user of the client application, such as user account data. The request may further include data related to the device or computing platform in which the client application 110 is running. Furthermore, the request may include an indication of which content is requested. For example, in the context of a digital learning curriculum, the request may specify a lesson (e.g., a lesson related to teaching sounds made by certain consonants in the alphabet as part of a literacy subject). In some embodiments, the request may include data that is used by the server application 102 to determine or generate a tailored plan.

At operation 194, the server application 102 may determine whether to use a tailored learning plan. For example, an example feature of the interactive digital learning system may be that users are provided content that is at least in part tailored to data associated with the user. In some embodiments, the server application 102 may determine to use a tailored learning plan based on determining one or more of the following: the received request includes data indicating that the tailored learning plan is to be used; the user has opted into the tailored learning plan or did not opt out of using the tailored learning plan; a tailored learning plan is available for the media content requested by the user; or another consideration. In response to determining to use a tailored learning plan (e.g., taking the “YES” branch) the server application 102 may proceed to the operation 196. In response to determining not to use the tailored learning plan (e.g., taking the “NO” branch), the server application 102 may proceed to the operation 198.

At operation 196, the server application 102 may determine tailored media content. In some embodiments, the server application 102 may use a base media content item to determine the tailored media content. For example, a lesson may be selected, including media content associated with the lesson. The media content may then be altered in part based on data associated with the user. For example, the server application 102 may determine a skill level of the user and adjust the media content based on the skill level of the user. For example, if the skill level of the user is higher than a threshold value, then a difficulty of an activity of the media content may be increased. Conversely, if the skill level of the user is lower than the threshold value, then a difficulty level of an activity of the media content may be decreased. In some embodiments, tailoring the media content may include selecting different media items (e.g., different videos, songs, activities, etc.) instead of or in addition to changing a difficulty level of an activity. In some embodiments, tailored media content may be selected or tailored based on historical activity data of the user, based on user preferences, or based on other data associated with the user. In some embodiments, the tailored media content may be part of a tailored set of media content for the user, such as a tailored curriculum for the user.

At operation 198, the server application 102 may select the requested content. For example, the server application 102 may retrieve, from the data storage service 162, media content specified in a request for media content.

At operation 200, the server application 102 may provide the media content. For example, the server application 102 may provide the content to the program that requested the content, such as the client application 110 In some embodiments, the server application 102 may stream the media content to the client application 110. In some embodiments, the server application 102 may provide the content to the client application 110 so that the client application 110 may download the media content. In some embodiments, the server application 102 may provide the client to the application 110 by using a content distribution network. In some embodiments, the server application 102 may provide the media content to the client application 110 in chunks. For example, the server application 102 may, at a first time, provide a first media content item (e.g., a movie or song) and then, at a second time, provide a second media content item (e.g., an activity). Once the content is received by the client application 110, the client application 110 may play the content, thereby causing an output display or sound at the device 108.

At operation 202, the client application 110 may receive interaction data. For example, via one or more input devices, such as one or more sensors, of the device 108 or a sensor or device coupled with the device 108, the client application 110 may receive data corresponding to user activity. For example, the client application 110 may receive one or more of visual, audio, or textual data corresponding to user activity. In some embodiments, the interaction data may be associated with an activity. For example, the interaction data may be speech translating a sentence from a first language to a second language. As other examples, the interaction data may include one or more of the following: user movement, user presence or absence, a user's surrounding, user emotional indicators like facial expression or body posture, user writing, an object or digital file created by the user, a user action in a game, a user health metric like heart rate or blood pressure, or other activity of the user or related to the user that may be captured by a device or sensor coupled with the client application 110 or server application 102. In some embodiments, the user interaction may not be directly associated with an activity but may nevertheless provide an indication of how the user is interacting with the media content (e.g., an image or video that may be used to determine the user's emotion). In some embodiments, the interaction data is captured in real time by the one or more sensors. For example, as the user is performing an action, such as speaking or moving, the sensors may be capturing such data and providing it to the client application 110 for processing, such as by applying the machine learning model to compare the user interaction data with data of the media content.

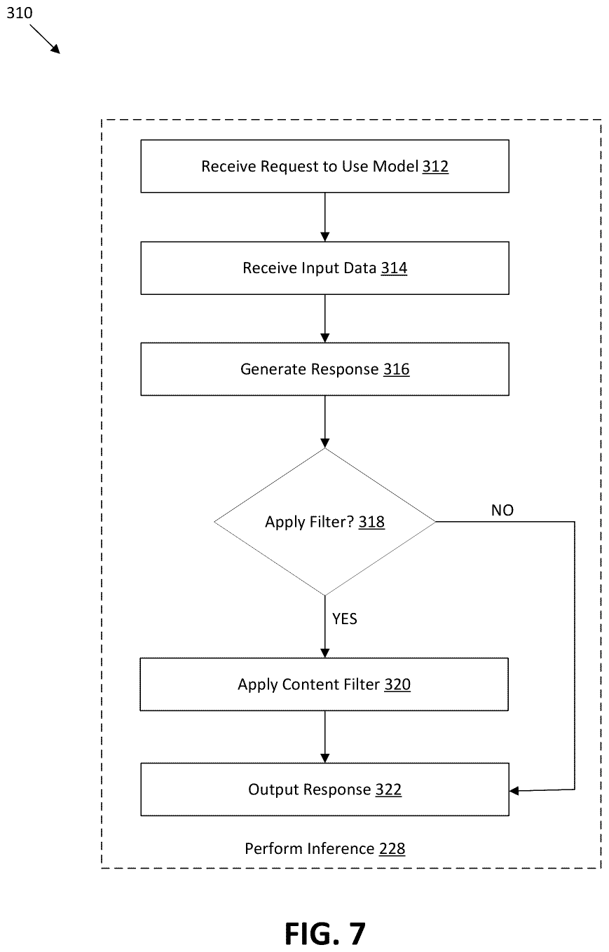

At operation 204, the client application 110 may evaluate user interaction data. For example, the client application 110 may input the user interaction data, or data derived at least in part from the user interaction data, into a trained machine learning model. In some embodiments, evaluating the user interaction data may be performed exclusively on the device 108, thereby obviating, in some instances, the need to send user interaction data to backend systems and across the internet. In some embodiments, at least some evaluation of the user interaction data may be performed by the server application 102 or another backend component. In some embodiments, one or more trained models 146 may be deployed to a server that is called by the client application 110 to evaluate user interaction data. In some embodiments, the evaluation may include comparing, in real time, the user interaction with data of the media content. As an example evaluation, the client application 110 may apply a speech recognition model 148 to user speech to determine the words spoken by the user and to determine whether the words were correct for a given activity. As another example, the client application 110 may apply a movement recognition model 152 to evaluate a user's movement and determine whether it sufficiently matches a movement of a character in the media content displayed on the screen. Other evaluations are likewise possible using the trained models 146. Example aspects of using the trained models 146 are further described in connection with FIG. 7. In some embodiments, the client application 110 may execute other programs instead of or in addition to a machine learning model to evaluate the user interaction data.

At operation 206, the client application 110 may provide feedback to the user. The feedback may depend, for example, on a result of the evaluation of user interaction data. For instance, in response to determining that the user translated a sentence (or completed a different activity), the client application 110 may provide a score or other data corresponding to the user's performance to the user. In some embodiments, the client application 110 may provide a correction or recommendation to the user. In some embodiments, the client application 110 may provide a reward to the user, such as in response to a successful completion of an activity. In some embodiments, the reward may be a crypto token, such as a crypto token described in connection with the blockchain system 158. In some embodiments, the feedback may not be related to an activity and instead may be provided in response to other user activity data or other information. For example, in response to determining that the user looks confused, off-task, or disengaged, the client application 110 may provide feedback by modifying the media content to address the user's mood, such as by playing a song or asking the user to move. Other types of feedback are likewise possible. After providing feedback (or as part of providing feedback), the client application 110 may provide additional content, thereby returning to the operation 200.

FIGS. 4-7 illustrate example methods that may pertain to the AI system 138. For example, FIG. 4 illustrates a plurality of steps, example implementations of which are further described in connection with FIGS. 5-7. The methods of FIGS. 4-7 are described herein as being performed for an individual machine learning model. However, aspects of the methods of FIGS. 4-7 may be performed in connection with a plurality of machine learning models, including, for example, the machine learning models described in connection with FIG. 2.

FIG. 4 is a flowchart of an example method 220. Different components may perform different operations of the method 220. At operation 222, the training data generator 142 may generate training data. In some embodiments, the training data generator 142 may generate training from diverse populations, and that data may be used as part of training the machine learning models of the AI system 138. Furthermore, the training data generator 142 may generate different types of data, such that a variety of machine learning models trained for different tasks may be developed. Example operations for generating training data are described in connection with FIG. 5.

At operation 224, the model training system 144 may train a machine learning model using the generated training data. Example operations for training a model are described in connection with FIG. 6.

At operation 226, a component of the AI system 138, such as a model deployment service, may deploy the trained machine learning model. In some embodiments, the machine learning model may be deployed to the device 108. For example, the machine learning model may be provided to the device 108 with media content with which the machine learning model is to be used. In some embodiments, the machine learning model may be provided to the device 108 along with the client application 110. In some embodiments, deploying the model may include converting the model to a Tensor Flow Lite model and then deploying the Tensor Flow Lite model to a mobile device. In some embodiments, the machine learning model is deployed to a server that hosts the machine learning model and from which the machine learning model may be accessed. In some embodiments, once the machine learning model is deployed, the model may be further fine-tuned. For example, if deployed to the device 108, the machine learning model may be trained to adjust for ambient conditions at the device 108, such as ambient lighting or noise.

At operation 228, the deployed machine learning model may be used to perform an inference task. For example, the deployed machine learning model may be used to evaluate user interaction data. Example operations for using the machine learning model to perform an inference are described in connection with FIG. 7.

FIG. 5 is a flowchart of an example method 240 for generating training data (e.g., operation 222 of FIG. 4).

At operation 242, the training data generator 142 may collect data. In some embodiments, the training data generator 142 may collect data that represents the population with which the interactive digital learning system is to be implemented. For example, if there is media content for children from a particular background, age, and language, and for teaching a particular task, then the training data generator 142 may collect data related to children from that background, age, language, and related to that task. Furthermore, if there is media content (i.e., either the same media content or different media content) for children from a different background, age, or language, or for teaching a different task, then the training data generator 142 may collect data specific to that group or that task. In some embodiments, the training data generator 142 may collect data that is exclusively related to children or that predominately relates to children.

In some embodiments, the training data generator 142 may receive the data from a third-party system or application. As an example, if a model is to be configured to recognize speech of Spanish-speaking children from Costa Rica learning English, then the training data generator 142 (or another component coupled thereto) may receive data from a partner organization located in Costa Rica. This data (which could include audio or video recordings, images, documents, digital files, and so on) could be collected in a way that protects the security and privacy of the people that provide the data. For instance, any personally identifiable information may be removed or altered such that it cannot be used to identify the individual. For example, the data could be collected without names, dates, specific location information, and metadata, and the data could be scrubbed or otherwise altered so that, even as the data is being collected, it is anonymized. In some embodiments, at least some of the data may be mined from the internet. In some embodiments, the data may, following a granting of permission by the user, be collected from a user of the client application 110. Other techniques for collecting data are likewise possible.

At operation 244, the training data generator 142 may anonymize data. For example, data may be anonymized such that it is not possible to determine an identity of the person that provided the data. This may include, for example, altering the data, removing metadata, or removing other data.

At operation 246, the training data generator 142 may modify the data. For example, from one or more units of training data (e.g., audio clips, images, or text), the training data generator 142 may modify the data to generate additional training instances, thereby creating synthetic training data. In some embodiments, the training data generator 142 may modify the data so that it is useable to train a particular machine learning model. For example, the training data generator 142 may extract relevant portions of the data, or the training data generator 142 may generate labels for the training samples.

At operation 248, the training data generator 142 may determine whether to generate more training data. In some embodiments, the training data generator 142 may continually receive data and generate training data. In some embodiments, the training data generator 142 may evaluate the quantity and quality of the already generated training data to determine whether to generate more training data. In response to determining to generate more training data (e.g., taking the “YES” branch), the training data generator 142 may collect additional data. In response to determining not to generate more training data (e.g., taking the “NO” branch), the training data generator 142 may end the training data generation session (e.g., operation 250). The training data generator 142 may store the generated training data in the training data 166.

FIG. 6 is a flowchart of an example method 270 of training a model, such as a model to be used in the interactive digital learning system. In some embodiments, aspects of the method 270 may be used to perform aspects of the operation 224 (training model using generated training data) of the method 220 of FIG. 4. Although operations of the method 270 are described as being performed by the model training system 144, the operations of the method 270 may, depending on the embodiment, be performed by other components.

At operation 272, the model training system 144 may select a model. For example, the model training system 144 may select a base model from the base models 140. The model selected may depend on the task for which the model training system 144 is creating a model. For example, the model training system 144 may select a model that has been pretrained to perform a task or to process a data type (e.g., text data, audio data, visual data, etc.) that is similar to the task for which the model training system 144 is training a model. In some embodiments, selecting the model may include copying an instance of a large pretrained model.

At operation 274, the model training system 144 may retrieve training data. For example, the model training system 144 may retrieve at least some data generated by the training data generator 142 or from the data storage service 162. The training data selected may depend on the model that the model training system 144 will train and the task for which the model training system 144 will train the model. For example, if the model training system 144 will train the model to perform an image recognition task (e.g., identifying a mood of the user based on body or facial expression or evaluating a document created by the user), then the model training system 144 may retrieve training data that includes images and, in some instances, labels associated with the images (e.g., classifications or scores for the images). For other tasks and models, the model training system 144 may likewise vary the training data that is retrieved and used.

Furthermore, in some embodiments, the model training system 144 may retrieve training data that is specific to a population for which the model is to be deployed. There may be various manners in which the model training system 144 may perform this selective retrieval of training data. For example, in some embodiments, the model training system 144 may use various filters to retrieve training data. The filters may enable the model training system 144 to, for example, retrieve training data filtered by one or more of an age, an ethnicity, a culture, a region of the world, a religion, an accent, a native language, a secondary language, or other filter. By having access to such data and by retrieving a training data set that is specific to a target segment of the global population, the model training system 144 may train a model that is tailored to that target segment, thereby improving the performance of the model for that segment. For example, by training on data from the target segment, the model may more accurately and consistently recognize speech, identify emotion, recognize movement, translate language, filter content, and perform other tasks for that target segment of the global population, thereby improving performance of not only the model but also of the interactive digital learning system more generally.

At operations 276-284, the model training system 144 may train the model using the retrieved training data. If the base model is a pre-trained model, then training the model may include fine-tuning the pre-trained model. Fine-tuning the model may include adding one or more layers and updating parameters of the one or more new layers. Fine-tuning the model may include unfreezing at least some parameters (e.g., weights) of the base model and updating those weights based on performance using the retrieved training data. Other techniques for fine-tuning may likewise be implemented. If the base model is not pre-trained, then training the model may include training a base model from scratch using the retrieved training data. In some embodiments, the model training system 144 may train the model by using supervised learning with some aspects of the retrieved training data as inputs and other aspects of the retrieved training data as labels. In other embodiments, the model training system 144 may use semi-supervised, unsupervised, or reinforcement learning techniques. The training technique implemented may depend on the task for which the model is being trained. As shown, training the model may include repeatedly performing the operations 276, 278, 280, 282, and 284. Although an iteration of the operations 276, 278, 280, 282, and 284 is described in the context of a single training instance, the model training system 144 may use batches of instances to train the model.

At operation 276, the model training system 144 may select a training instance. A training instance may include an example unit of data that is similar in scope to the data for which the model is to be deployed. For example, if the model is being trained to recognize words in speech of Spanish-speaking children from Costa Rica who are learning English, then the training instance may be a phrase spoken in English by a Spanish-speaking child from Costa Rica.

At operation 278, the model training system 144 may provide the training instance to the model. Continuing with the example, the model training system 144 may provide the English phrase to the model. In some embodiments, prior to providing the training instance to the model, one or more pre-processing tasks may be performed. In the example of audio data, this may include clipping the data file, normalizing the amplitude, removing background noise, or performing other tasks. In the context of other data types, other pre-processing tasks may be applied to prepare the data for use with the model.

At operation 280, the model may predict an output for the training instance. The type of data output by the model may depend on the task. Continuing with the example, the model may output one or more words that the model determined were spoken by the child. For other tasks, the model may output different types of data. In some embodiments, the predicted output may be in the form of embeddings generated by the model.

At operation 282, the model training system 144 may determine a loss. For example, the model training system 144 may evaluate the output of the model and data that the model should have output. For example, the model training system 144 may use an objective function to evaluate a difference between what the model output and what the model should have output. In some embodiments, the loss may be determined based on a difference in embeddings. Depending on the embodiments, the loss function may be a cross-entropy loss function or mean squared error. In some embodiments a plurality of loss functions may be used. In some embodiments, the model training system 144 may seek to maximize or minimize the objective function during training of the model.

At operation 284, the model training system 144 may backpropagate the loss. For example, the model training system 144 may update one or more weights of the model based at least in part on an evaluation including the model's output and the correct output for the training instance. In some embodiments, backpropagating the loss may include updating one or more layers of the base model, whereas in other embodiments, such weights may be frozen and only layers added to the base model may be updated.

After the operation 284, the model training system 144 may return to the operation 276, select a different training instance (or batch of training instances), and train the model using this next training instance.

Depending on the embodiment and the available training data, the model training system 144 may continuously perform the operations 276-284 until, for example, each available training instance has been used, until a pre-defined number of epochs is complete, until a threshold performance level of the model is attained, or until a subset of the available training instances has been used.

At operation 286, the model training system 144 may prepare the model for deployment. This may include performing one or more optimization processes on the model to increase the model's inference speed or to reduce the model's size. In some embodiments, preparing the model for deployment may include converting the model into a different format. For example, in some embodiments, the model training system 144 may convert the model into a format that is configured to operate in a computing platform of the device 108. As an example, the model training system 144 may convert the model into a Tensor Flow Lite model so that the model can be deployed to a mobile phone.

FIG. 7 is a flowchart of an example method 310. In some embodiments, aspects of the method 310 may be used to perform aspects of the operation 228 (performing inference) of the method 220 of FIG. 4. Although operations of the method 310 are described as being performed by the client application 110, operations of the method 310 may, depending on the embodiment, be performed by other components. For example, the server application 102 may perform aspects of the method 310.

At operation 312, the client application 110 may receive a request to use the model. For example, as part of evaluating interaction data of a user (e.g., as described in connection the operations 200-206 of FIG. 3), the client application 110 may determine to use a machine learning model. The request may include an identification of the model to be used as well as other parameters that may be used by the model.

At operation 314, the client application 110 may receive input data. The input data may include or be derived from user interaction data, as described in connection with the operation 202 of FIG. 3. In some embodiments, the client application 110 may receive or generate the request to use the model and the input data as part of a common operation.

At operation 316, the client application 110 may generate a response. For example, the client application 110 may provide the input data to the model, which may generate a response. In some embodiments, generating the response may further include applying pre-processing or post-processing tasks. In some embodiments, applying the machine learning model and generating the response may be performed by only using components of the device 108, thereby obviating the need to send user interaction data or response data across the internet or to other machines for processing.

At operation 318, the client application 110 may determine whether to apply a filter. For example, the client application 110 may apply a filter to the response generated by the machine learning model to verify that the response is appropriate to output or to alter the response. In some embodiments, to determine whether to apply a filter, the client application 110 may check account data for the user to determine whether a filter has been switched on, and if so, the client application 110 may identify the filter. In some embodiments, the filter may be selected and turned on or off by using supervisor features of the client application 110. In some embodiments, the client application 110 may determine whether to apply a filter based on an age, location, or other data associated with the user. In some embodiments, a content filter may only be applied to generative models. In response to determining to apply a filter (e.g., taking the “YES” branch), the client application 110 may proceed to the operation 320. In response to determining not to apply the filter (e.g., taking the “NO” branch), the client application 110 may proceed to the operation 322.

At operation 320, the client application 110 may apply a content filter. In some embodiments, the content filter may be a machine learning model, as described in connection with FIG. 2. The content filter need not, however, only be a machine learning model and instead may include other techniques for filtering content, such as by using a human to check certain content. In some embodiments, the content filter may be selected based at least in part on a selection of a content filter of a supervisor feature of the client application 110. For example, a supervisor may select a content filter that requires that the output not have or have certain content, subjects, viewpoints, world views, and so on. In some embodiments, the content filter may require that outputs have or not have certain material. In some embodiments, a plurality of content filters may be applied.

At operation 322, the client application 110 may output a response. If the content is filtered, the client application 110 may output the filtered content. If not, the client application 110 may output the unfiltered context. In some embodiments, the client application 110 may integrate the response of the machine learning model with other media content. For example, if the machine learning model determines that a phrase includes a set of words, the client application 110 may determine whether that set of words is accurate in the context of an activity. Based on this determination, the client application 110 may alter the feedback provided to the user. As another example, the machine learning model may indicate that the user is frustrated with an activity. In response, the client application 110 may switch the media content or decrease the difficulty of the activity. In these and other ways, the client application 110 may use the machine learning models to provide content that is responsive to the user's activity.

FIG. 8 is a flowchart of an example method 350 for integrating blockchain technology and crypto tokens with the interactive digital learning system. Although described as being performed by the blockchain system 158, other components may perform aspects of the method 350, such as the server application 102 or the client application 110.

At operation 352, the blockchain system 158 may create crypto tokens. For example, the blockchain system 158 may select an underlying blockchain that is to support the crypto token. Furthermore, the blockchain system 158 may define characteristics of the tokens, which may include assigning values to different tokens, defining whether the tokens can be exchanged (and if so, defining how the crypto tokens can be exchanged and what the crypto tokens can be exchanged for), defining whether the tokens are fungible or non-fungible, associating the crypto tokens with other assets, or defining other characteristics of the crypto tokens.

At operation 354, the blockchain system 158 may define smart contracts related to the crypto tokens. This may include writing and deploying code to the blockchain that defines how and when the crypto tokens can be used, gained, exchanged, and so on.

At operation 356, the crypto tokens may be integrated into one or more of the server application 102 or the client application 110. For example, the server application 102 may be configured to track and manage the crypto tokens across different instances of the client application 110. The client application 110 may be configured to manage crypto tokens for a particular user.

In an example implementation of crypto tokens, the client application 110 may award a user with tokens after successful completion of an activity, a lesson, or a subject. The more activities, lessons, and subjects completed by the user, the more crypto tokens the user may attain. In some embodiments, the crypto tokens become progressively more valuable as the user progresses through a curriculum. In some embodiments, if the user reaches a milestone (e.g., 6 weeks of completed lessons or a streak of 5 days in a row), the user may have the opportunity to multiply the value of the crypto tokens that the user has already received. In some embodiments, if the user collects a defined set of tokens, the user may be awarded a crypto token that has the highest value. In some embodiments, the crypto tokens may be exchanged for additional content (e.g., media content or accessories such as costumes, props, etc.) in the interactive digital learning system. In some embodiments, the crypto tokens may be exchanged for other crypto assets, such as Bitcoin or another crypto asset.

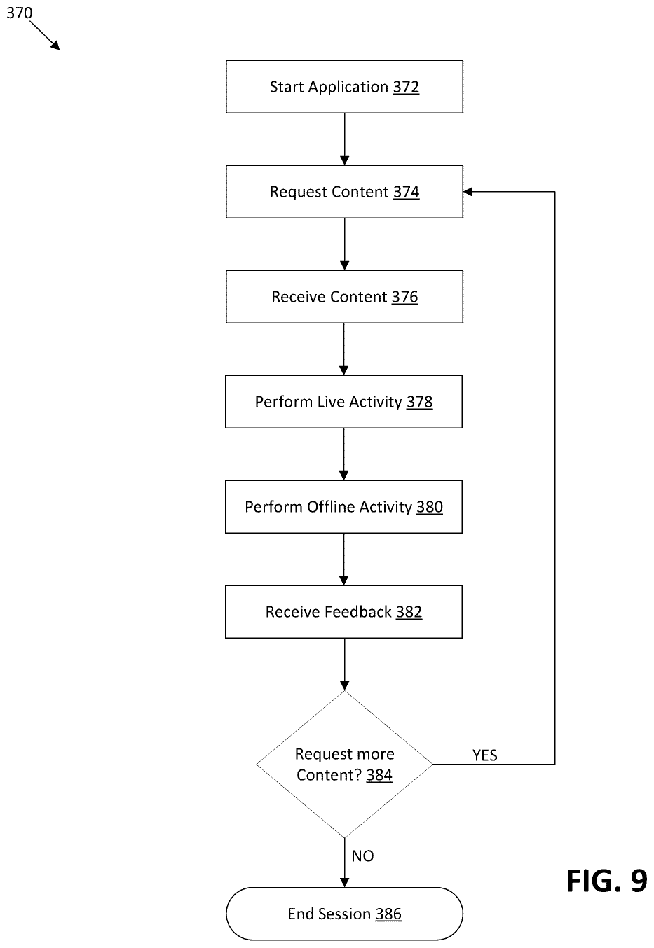

FIG. 9 is a flowchart of an example method 370 that may be used by a user of the interactive digital learning system, such as the user U of FIG. 1. As described in connection with FIGS. 1-2, the client application 110 may, depending on the embodiment, be implemented across a plurality of computing platforms. In some embodiments, aspects of the method 370 may be used independently of the platform on which the client application 110 is used.

At operation 372, the user may start the client application 110. This may include selecting an icon in a graphical user interface of the device 108. In some embodiments, the client application 110 may automatically start in response to detecting a presence of the user or at a particular date or time of day.

At operation 374, the user may request content. In some embodiments, this may include selecting a GUI element corresponding to media content that the user is requesting. For example, using navigation tools of the GUI, such as text input fields, hierarchically organized, selectable fields, an audio input feature, or another feature, the user may navigate to content that the user would like to play. This may be a particular lesson or subject of a digital learning curriculum. In some embodiments, the user may simply select a button for the next lesson. After the user selects content, the client application may retrieve the requested content or generate a request for the requested content that is provided to the server application 102. In some embodiments, at least some of the media content may cached or otherwise stored on the device 108.

At operation 376, the user may receive content. For example, the client application 110 may play media content, which may include aspects of the media content 164 described in connection with FIG. 2. As described in connection with FIG. 3, the content may, in some embodiments, be tailored to the user.

At operations 378-380, the user may perform activities. For example, the media content played by the client application 110 may include activities. Some activities may be live activities, which may be activities that are performed while the media content is playing. In some instances, live activities may include communication with the server application 102, whereas in other instances, live activities may only require data exchanges with the device 108 or a private local network. Examples of live activities may include interacting with a character, playing a game, or otherwise interacting with content provided by the client application 110 in real-time. Some activities may be offline activities, which may be activities that the user performs while the client application is suspended, not actively providing new content, or not interacting with the user. Examples of offline activities may include creating a document, practicing a skill, or teaching a skill. Following an offline activity, the user may provide a created product (e.g., an image of the product or a digital file representing the product) to the client application 110 or demonstrate a skill to the client application 110.

At operation 382, the user may receive feedback. The feedback may relate to evaluating the user's performance during the activity or may relate to providing the user with an award, as described in connection with FIG. 3. The feedback may include additional content. The feedback may include data that can be tracked via a dashboard accessible to the user. In some embodiments, the user may also receive feedback during other operations of the method 370.

At operation 384, the user may request more content. For example, the user may select additional content in the client application 110. The user may select, for example, a next lesson in a curriculum. In some embodiments, the client application 110 may automatically generate a request for new content unless the user indicates otherwise. In some embodiments, the client application 110 may limit the amount of content available to the user during a time period, a limitation that may be set using a supervisor feature of the client application 110. In response to determining to request more content (e.g., taking the “YES” branch), the method 370 may return to operation 374. In response to determining not to request more content (e.g., taking the “NO” branch), the session may end.

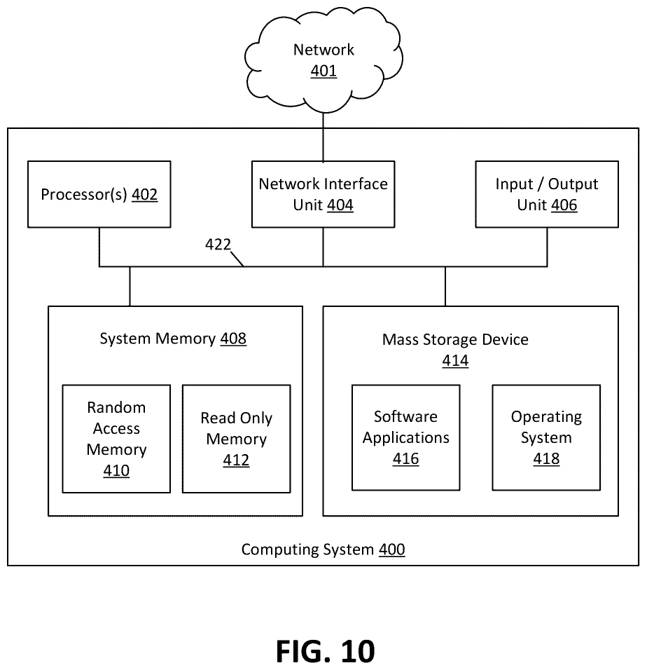

FIG. 10 illustrates an example block diagram of a virtual or physical computing system 400. One or more aspects of the computing system 400 can be used to implement systems, components, and processes described herein.

In the embodiment shown, the computing system 400 includes one or more processors 402, a system memory 408, and a system bus 422 that couples the system memory 408 to the one or more processors 402. The system memory 408 includes RAM (Random Access Memory) 410 and ROM (Read-Only Memory) 412. A basic input/output system that contains the basic routines that help to transfer information between elements within the computing system 400, such as during startup, is stored in the ROM 412. The computing system 400 further includes a mass storage device 414. The mass storage device 414 is able to store software instructions and data. The one or more processors 402 can be one or more central processing units or other processors.

The mass storage device 414 is connected to the one or more processors 402 through a mass storage controller (not shown) connected to the system bus 422. The mass storage device 414 and its associated computer-readable data storage media provide non-volatile, non-transitory storage for the computing system 400. Although the description of computer-readable data storage media contained herein refers to a mass storage device, such as a hard disk or solid-state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, DVD (Digital Versatile Discs), other optical storage media, magnetic cassettes, magnetic tape, magnetic disk storage or other magnetic storage devices, or any other medium which can be used to store the desired information and which can be accessed by the computing system 400.

According to various embodiments of the invention, the computing system 400 may operate in a networked environment using logical connections to remote network devices through the network 401. The network 401 is a computer network, such as an enterprise intranet and/or the Internet. The network 401 can include a LAN, a Wide Area Network (WAN), the internet, wireless transmission mediums, wired transmission mediums, other networks, and combinations thereof. The computing system 400 may connect to the network 401 through a network interface unit 404 connected to the system bus 422. It should be appreciated that the network interface unit 404 may also be utilized to connect to other types of networks and remote computing systems. The computing system 400 also includes an input/output controller 406 for receiving and processing input from a number of other devices, including a touch user interface display screen, or another type of input device. Similarly, the input/output controller 406 may provide output to a touch user interface display screen or other type of output device.

As mentioned briefly above, the mass storage device 414 and the RAM 410 of the computing system 400 can store software instructions and data. The software instructions include an operating system 418 suitable for controlling the operation of the computing system 400. The mass storage device 414 and/or the RAM 410 also store software instructions, that when executed by the one or more processors 402, cause one or more of the systems, devices, or components described herein to provide functionality described herein. For example, the mass storage device 414 and/or the RAM 410 can store software instructions that, when executed by the one or more processors 402, cause the computing system 400 to receive and execute managing network access control and build system processes.

While particular uses of the technology have been illustrated and discussed above, the disclosed technology can be used with a variety of data structures and processes in accordance with many examples of the technology. The above discussion is not meant to suggest that the disclosed technology is only suitable for implementation with the components and operations shown and described above.

This disclosure described some aspects of the present technology with reference to the accompanying drawings, in which only some of the possible aspects were shown. Other aspects can, however, be embodied in different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

What is claimed is:

1. An interactive digital learning system, the system comprising:
a server; and
a client device communicatively coupled with the server;
wherein the server comprises a processor and memory storing instructions that, when executed by the processor, cause the server to:
fine-tune a machine learning model using training data specific to a background of a user by:
collecting data from a target segment of a global population, the target segment having features that correspond to the background of the user;
based on the data collected from the target segment of the global population, generating training samples for training the machine learning model to perform a task;
selecting a pre-trained base model for the machine learning model; and
training the pre-trained base model using the training samples;
deploy the machine learning model to the client device of the user;
stream media content associated with a lesson to the client device;
wherein the client device comprises a second processor and second memory storing second instructions that, when executed by the second processor, cause the client device to:
receive the deployed machine learning model;
receive the streamed media content associated with the lesson;
play the streamed media content to display the media content on a screen;
capture, using a sensor, user interaction data in real time;
apply the machine learning model to compare, in real time at the client device, the streamed media content and the user interaction data;
based on the comparison of the streamed media content and the user interaction data, generate feedback; and
display the feedback on the screen.

2. The interactive digital learning system of claim 1,
wherein the sensor comprises a camera;
wherein the interaction data comprises visual data; and
wherein applying the machine learning model to compare, in real time at the client device, the streamed media content and the user interaction data comprises using the machine learning model to infer a similarity between the visual data and the streamed media content displayed on the screen.

3. The interactive digital learning system of claim 1, wherein the sensor is a heart rate sensor attached to the user.

4. The interactive digital learning system of claim 1, wherein fine-tuning the machine learning model using training data specific to the user further comprises anonymizing the data from the target segment of the global population by removing metadata and scrubbing personally identifiable information.

5. The interactive digital learning system of claim 1, wherein the background of the user includes one or more of an age, a location, an ethnic background, or a linguistic background.

6. The interactive digital learning system of claim 1, wherein the media content includes a video, a song, and an activity.

7. The interactive digital learning system of claim 1, wherein the lesson relates to one or more of literacy or math.

8. The interactive digital learning system of claim 1,
wherein the sensor is a microphone;
wherein the user interaction data is user speech.

9. The interactive digital learning system of claim 1, wherein the user interaction data is user movement.

10. The interactive digital learning system of claim 1, wherein displaying the feedback on the screen comprises:
providing a crypto token to the user; or
providing a recommendation to the user.

11. The interactive digital learning system of claim 1,
further comprising a second machine learning model, wherein the second machine learning model is trained at least in part using a second set of training data specific to a second background of a second user, the second background of the second user being different from the background of the user; and
wherein the second machine learning model is deployed to a second client device of the second user.

12. The interactive digital learning system of claim 1, wherein the client device is a mobile phone or a virtual reality headset.

13. A method for facilitating an interactive digital education system, the method comprising:
by a server:
generating media content, at least some of the media content being associated with a curriculum;
training a plurality of machine learning models, wherein each machine learning model of the plurality of machine learning models is trained using data associated with a different user background, wherein training a machine learning model of the plurality of machine learning models comprises:
collecting data from a target segment of a global population, the target segment having features that correspond to a background of a user;
based on the data collected from the target segment of the global population, generating training samples for training the machine learning model to perform a task;
selecting a pre-trained base model for the machine learning model; and
training the pre-trained base model using the training samples;
distributing the media content across a plurality of client devices; and
deploying the plurality of machine learning models across the plurality of client devices;
by a client device of the plurality of client devices:
playing the media content using a screen and a speaker;
capture, using a sensor, user interaction data; and
apply the machine learning model on the client device to compare the media content and the user interaction data.

14. The method of claim 13, further comprising, by the client device:
anonymizing the user interaction data; and
providing the anonymized user interaction data to the server to re-train the machine learning model.

15. The method of claim 13, further comprising, by the client device, using the machine learning model to generate a response to the user interaction data captured by the sensor.

16. The method of claim 13,
wherein the target segment of the global population consists of children; and
wherein the user is a child.

17. The method of claim 13,
wherein the screen is part of a television communicatively coupled with the client device; and
wherein the television is not communicatively coupled directly with the server.

18. The method of claim 13,
wherein the sensor is a microphone;
wherein the user interaction data is user speech; and
wherein applying the machine learning model comprises comparing the user speech with audio data of the media content output by the speaker.

19. The method of claim 13, wherein the sensor is external to the client device.

20. A system for facilitating digital interaction with machine learning, the system comprising:
a server communicatively coupled with a client device via a network;
wherein the server is configured to:
access data for a target segment of a global population, the target segment having features that correspond to a background of a user associated with the client device;
using the data for the target segment of the global population, generate labeled training samples for training a machine learning model to perform a task;
select a pre-trained base model for the machine learning model;
train the pre-trained base model using the labeled training samples; and
deploy the machine learning model to the client device;
wherein the client device is configured to:
receive the deployed machine learning model;
receive media content;
play the media content;
capture, using a sensor, user interaction data; and
apply the machine learning model at the client device to evaluate the user interaction data.
